(19) United States
(12) Patent Application Publication
(10) Pub. No.: US 2022/0375187 A1
(43) Pub. Date: Nov. 24, 2022

(54) METHOD OF PERFORMING OBJECT SEGMENTATION ON VIDEO USING SEMANTIC SEGMENTATION MODEL, DEVICE AND STORAGE MEDIUM

(71) Applicant: BEIJING BAIDU NETCOM SCIENCE TECHNOLOGY CO., LTD., Beijing (CN)

(72) Inventor: Jian ZHANG, Beijing (CN)

(73) Assignee: BEIJING BAIDU NETCOM SCIENCE TECHNOLOGY CO., LTD., Beijing (CN)

(21) Appl. No.: 17/872,304

(22) Filed: Jul. 25, 2022

(30) Foreign Application Priority Data
Jul. 26, 2021 (CN) 202110847159.7

(51) Int. Cl. G06V 10/26; G06V 10/80; G06V 10/77; G06V 10/94; G06V 20/40

(52) U.S. Cl. CPC G06V 10/26; G06V 10/806; G06V 10/7715; G06V 10/95; G06V 20/41; G06V 20/49; G06V 20/54

(57) ABSTRACT

A method of performing an object segmentation on a video using a semantic segmentation model, a device, and a storage medium, which relate to a field of artificial intelligence, in particular to computer vision and deep learning technologies. The method includes: sequentially inputting a current video frame and a previous video frame into a first feature extraction network to obtain a feature map sequence; sequentially inputting object segmentation information of the previous video frame into a second feature extraction network to obtain a segmentation feature sequence; sequentially inputting the current video frame and the previous video frame into a temporal encoding network to obtain a temporal feature sequence; generating a fused feature sequence based on the feature map sequence, the segmentation feature sequence and the temporal feature sequence; and inputting the fused feature sequence into a segmentation network to obtain an object segmentation information of the current video frame.

This application claims priority to Chinese Patent Application No. 202110847159.7, filed on Jul. 26, 2021, which is incorporated herein in its entirety by reference.

### TECHNICAL FIELD

The present disclosure relates to a field of an artificial intelligence technology, in particular to fields of computer vision and deep learning technologies, and specifically can be applied in smart city and intelligent cloud scenarios.

### BACKGROUND

With a development of a computer technology and a network technology, a computer vision technology has been widely used. For example, the computer vision technology may be used to detect, classify and segment an object. Using the computer vision technology to segment a video may achieve a tracking of a target object in a smart city scenario.

### SUMMARY

The present disclosure provides a method of performing an object segmentation on a video using a semantic segmentation model, a device, and a storage medium.

According to an aspect of the present disclosure, a method of performing an object segmentation on a video using a semantic segmentation model is provided, wherein the semantic segmentation model includes a first feature extraction network, a second feature extraction network, a temporal encoding network, a feature fusion network and a segmentation network, and the method includes: sequentially inputting a current video frame and a previous video frame into the first feature extraction network to obtain a feature map sequence; sequentially inputting object segmentation information of the previous video frame into the second feature extraction network to obtain a segmentation feature sequence; sequentially inputting the current video frame and the previous video frame into the temporal encoding network to obtain a temporal feature sequence; generating a fused feature sequence using the feature fusion network based on the feature map sequence, the segmentation feature sequence and the temporal feature sequence; and inputting the fused feature sequence into the segmentation network to obtain an object segmentation information of the current video frame.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method of performing an object segmentation on a video using a semantic segmentation model.

According to another aspect of the present disclosure, a non-transitory computer-readable storage medium having computer instructions therein is provided, wherein the computer instructions are configured to cause a computer to implement the method of performing an object segmentation on a video using a semantic segmentation model.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, wherein:

FIG. 1 shows a schematic diagram of an application scenario of a method and an apparatus of performing an object segmentation on a video using a semantic segmentation model according to embodiments of the present disclosure;

FIG. 2 shows a schematic flowchart of a method of performing an object segmentation on a video using a semantic segmentation model according to embodiments of the present disclosure;

FIG. 3 shows a schematic diagram of a method of performing an object segmentation on a video using a semantic segmentation model according to embodiments of the present disclosure;

FIG. 4 shows a schematic diagram of generating an object segmentation information of a current video frame according to embodiments of the present disclosure;

FIG. 5 shows a schematic diagram of generating a fused feature sequence using a feature fusion network according to embodiments of the present disclosure;

FIG. 6 shows a structural block diagram of an apparatus of performing an object segmentation on a video using a semantic segmentation model according to embodiments of the present disclosure; and

FIG. 7 shows a block diagram of an electronic device for implementing the method of performing the object segmentation on the video using the semantic segmentation model according to embodiments of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

The present disclosure provides a method of performing an object segmentation on a video by using a semantic segmentation model, including a feature map generation stage, a segmentation feature generation stage, a temporal feature generation stage, a fused feature generation stage, and an object segmentation stage. The semantic segmentation model includes a first feature extraction network, a second feature extraction network, a temporal encoding network, a feature fusion network and a segmentation network. In the feature map generation stage, a current video frame and a previous video frame are sequentially input into the first feature extraction network to obtain a feature map sequence. In the segmentation feature generation stage, object segmentation information of the previous video frame are sequentially input into the second feature extraction network to obtain a segmentation feature sequence. In the temporal feature generation stage, the current video frame and the previous video frame are sequentially input into the temporal encoding network to obtain a temporal feature sequence. In the fused feature generation stage, a fused feature sequence is generated using the feature fusion network based on the feature map sequence, the segmentation feature sequence and the temporal feature sequence. In the object segmentation stage, the fused feature sequence is input into the segmentation network to obtain an object segmentation information of the current video frame.

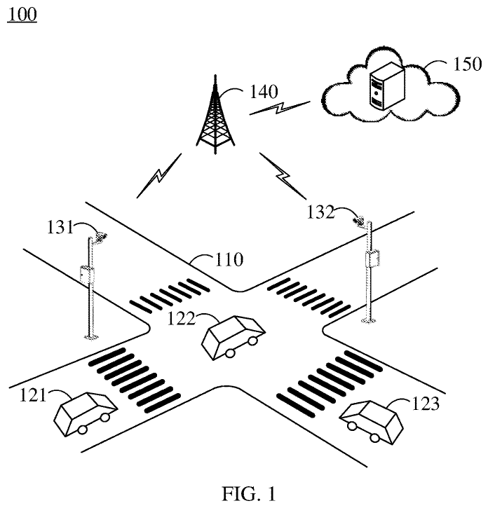

An application scenario of the method and apparatus provided by the present disclosure will be described below with reference to FIG. 1.

FIG. 1 shows a schematic diagram of an application scenario of a method and an apparatus of performing an object segmentation on a video using a semantic segmentation model according to embodiments of the present disclosure. It should be understood that the scenario shown in FIG. 1 is only an application scenario of the method and the apparatus provided by the present disclosure, and the method and the apparatus provided by the present disclosure may also be applied to any scenario that needs to perform an object segmentation on a video, which is not limited in the present disclosure.

As shown in FIG. 1, a scenario 100 of this embodiment includes a road 110, vehicles 121 to 123 driving on the road, and video capture devices 131 to 132. The video capture devices 131 to 132 are arranged on both sides of the road 110. The video capture devices 131 to 132 may be used to capture video data within a monitoring range, so as to monitor vehicles on the road. The captured video data may be used as, for example, a reference for an accident determination or a violation determination.

In an embodiment, as shown in FIG. 1, the application scenario may further include a roadside base station 140 and an intelligent cloud platform 150. The video capture devices 131 to 132 may be communicatively connected to the intelligent cloud platform 150, for example, through the roadside base station 140, so as to upload the captured video data to the intelligent cloud platform 150. The intelligent cloud platform 150 may perform an object segmentation on the video data captured by the video capture devices, for example, using a semantic segmentation model, so as to track an object. The tracked object may be, for example, an illegal vehicle.

According to embodiments of the present disclosure, the intelligent cloud platform may perform the object segmentation on the video, for example, using a Spatio-Temporal Memory (STM) technology or based on a distance map. The STM technology may be implemented to store historical frame data of the video by constructing an external storage, and retrieve and reintegrate an information in the external storage by constructing a key-value information when performing an object segmentation on a current frame image of the video, so as to obtain an enhanced feature description. Finally, the object segmentation is performed on the current frame image based on the enhanced feature description. The distance map-based technology is originally derived from a Fast End-to-End Embedding Learning for Video Object Segmentation (FEELVOS) model and is implemented to generate a distance map information by constructing a distance between an object of each frame and a corresponding object in a reference frame and a historical frame. The object segmentation of the current frame image may be performed based on the distance map information and a feature map obtained from an image through a backbone network.

According to embodiments of the present disclosure, when performing the object segmentation on the video, for example, a temporal information of each frame image in the video data may also be considered, so as to improve a control over a feature in a temporal dimension, and avoid an influence of a historical frame with an inaccurate prediction result on subsequent image processing. Specifically, the video segmentation may be achieved by using a method of performing an object segmentation on a video using a semantic segmentation model described below.

It should be noted that the method of performing the object segmentation on the video using the semantic segmentation model provided by embodiments of the present disclosure may be performed by the intelligent cloud platform. Accordingly, an apparatus of performing an object segmentation on a video using a semantic segmentation model provided by embodiments of the present disclosure may be arranged in the intelligent cloud platform.

It should be understood that the number and type of vehicles, video capture devices, roadside base station and intelligent cloud platform shown in FIG. 1 are merely illustrative. According to implementation needs, any number and type of vehicle, video capture device, roadside base station and intelligent cloud platform may be provided.

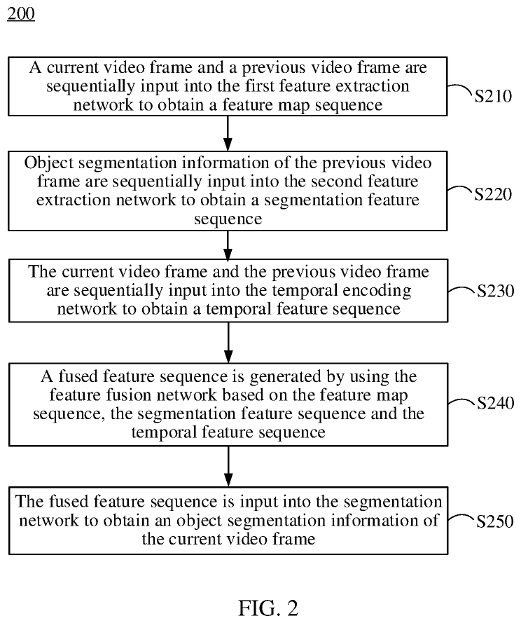

The method of performing the object segmentation on the video using the semantic segmentation model provided by the present disclosure will be described in detail below through FIGS. 2 to 5 with reference to FIG. 1.

FIG. 2 shows a schematic flowchart of a method of performing an object segmentation on a video using a semantic segmentation model according to embodiments of the present disclosure.

As shown in FIG. 2, a method 200 of performing an object segmentation on a video using a semantic segmentation model in this embodiment may include operations S210 to S250. The semantic segmentation model may include a first feature extraction network, a second feature extraction network, a temporal encoding network, a feature fusion network and a segmentation network.

In operation S210, a current video frame and a previous video frame are sequentially input into the first feature extraction network to obtain a feature map sequence.

According to embodiments of the present disclosure, the first feature extraction network may include Residual Neural Network (ResNet) or DarkNet framework or the like. In this embodiment, the current video frame and the previous video frame may be sequentially input into the first feature extraction network from front to back or from back to front based on a temporal order, and the first feature extraction network may output a feature map of each video frame. The feature maps output in sequence constitute a feature map sequence. In an embodiment, the first feature extraction network may include ResNet 50 network.

According to embodiments of the present disclosure, a number of the previous video frame may be set to any integer greater than 1 according to actual requirements, such as 5. Specifically, in a video segmentation task, the number of the previous video frame may be dynamically set, so as to avoid an influence of a wrong segmentation result of the previous video frame on a segmentation result of a subsequent video frame, and avoid passing on errors indefinitely.

In operation S220, object segmentation information of the previous video frame are sequentially input into the second feature extraction network to obtain a segmentation feature sequence.

According to embodiments of the present disclosure, the second feature extraction network is similar to the first feature extraction network described above. Considering that the object segmentation information is generally a mask image, which expresses less information than a video frame, an architecture of the second feature extraction network may be set simpler than an architecture of the first feature extraction network. For example, if the first feature extraction network includes ResNet 50 network, the second feature extraction network may include ResNet 18 network.

When the previous video frame is a start frame of the video, the object segmentation information may be obtained, for example, by labeling in advance. That is, the object segmentation information is a segmentation mask label of the start frame, which is an actual object segmentation information. When the previous video frame is a video frame subsequent to the start frame, the object segmentation information may be a predicted object segmentation information obtained by using the method of performing the object segmentation on the video using the semantic segmentation model in this embodiment. Therefore, the method of performing the object segmentation on the video in this embodiment is substantially a semi-supervision method. The object segmentation information of the previous video frame may be used as a reference information for the object segmentation of the current video frame, so as to facilitate an extraction of feature data of the current video frame and facilitate an understanding of a video content.

The previous video frame may include, for example, a plurality of video frames. In this embodiment, the object segmentation information of the plurality of previous video frames may be sequentially input into the second feature extraction network from front to back or from back to front based on a temporal order, and the second feature extraction network may output a segmentation feature of the object segmentation information of each video frame. The segmentation features output in sequence constitute a segmentation feature sequence.

In operation S230, the current video frame and the previous video frame are sequentially input into the temporal encoding network to obtain a temporal feature sequence.

According to embodiments of the present disclosure, the temporal encoding network may encode a temporal information of each video frame, for example, using a sine wave encoding method, a learning encoding method, or a relative time expression method, so as to obtain a temporal code value. The temporal code value is replicated in two dimensions to obtain H*W temporal codes which may form a matrix M^{H×W} representing the temporal feature of a video frame, wherein H and W respectively represent a height and a width of the video frame.

For example, in operation S230, the current video frame and the previous video frame may be sequentially input into the temporal encoding network from front to back or from back to front based on a temporal order, and the temporal encoding network may generate a temporal feature of each input video frame using the sine wave encoding method based on a temporal information of the input video frame relative to the start frame. The temporal features sequentially output by the temporal encoding network constitute a temporal feature sequence. A value TE(t) of each element in the temporal code obtained by using the sine wave encoding method may be expressed as:

$$TE ( t ) = sin ( \frac{t}{T} ) ,$$

wherein t represents a time interval between each video frame and the start frame, and T represents a total duration of the video.

In operation S240, a fused feature sequence is generated using the feature fusion network based on the feature map sequence, the segmentation feature sequence and the temporal feature sequence.

According to embodiments of the present disclosure, the feature fusion network may, for example, concatenate the feature map sequence, the segmentation feature sequence and the temporal feature sequence using a concat( ) function.

For example, for each previous video frame, the feature fusion network may sequentially concatenate the feature map, the segmentation feature and the temporal feature in a channel dimension to obtain feature data of each previous video frame. For the current video frame, the feature fusion network may concatenate the feature map and the temporal feature in the channel dimension to obtain feature data of the current video frame. Then, the feature data of the previous video frame and the feature data of the current video frame constitute the fused feature sequence.

For example, the feature fusion network may further concatenate the feature map and the temporal feature of the previous video frame in the channel dimension in the unit of frame to obtain a memory feature. Then, a concatenation is performed on the segmentation feature of the previous video frame in the channel dimension so as to obtain a mask feature. Finally, the mask feature, the feature data of the current video frame and the memory feature are aggregated to obtain the fused feature sequence.

In operation S250, the fused feature sequence is input into the segmentation network to obtain an object segmentation information of the current video frame.

According to embodiments of the present disclosure, the segmentation network may adopt, for example, a decoder structure in a semantic segmentation model in an existing method. For example, a decoder structure in U-Net models, Fully Convolution Networks (FCNs) or SegNet networks may be adopted.

In this embodiment, the fused feature sequence may be input into the segmentation network, and the segmentation network outputs a heat map of the current video frame. A color of a pixel where the object is located in the heat map is different from a color of other pixels, so as to achieve the segmentation of the object. In this embodiment, the heat map may be used as the segmentation information of the current video frame.

To sum up, in embodiments of the present disclosure, when the object segmentation is performed on the video, by generating the temporal feature through temporal encoding of each video frame in the input video frame, and by comprehensively considering the feature map and the temporal feature, a temporal association between an object to be segmented in the video frame and an object in the historical frame may be effectively mined, so that an accuracy of the object segmentation of the video may be improved, and an accurate reference information may be provided for a downstream application (such as object tracking, etc.).

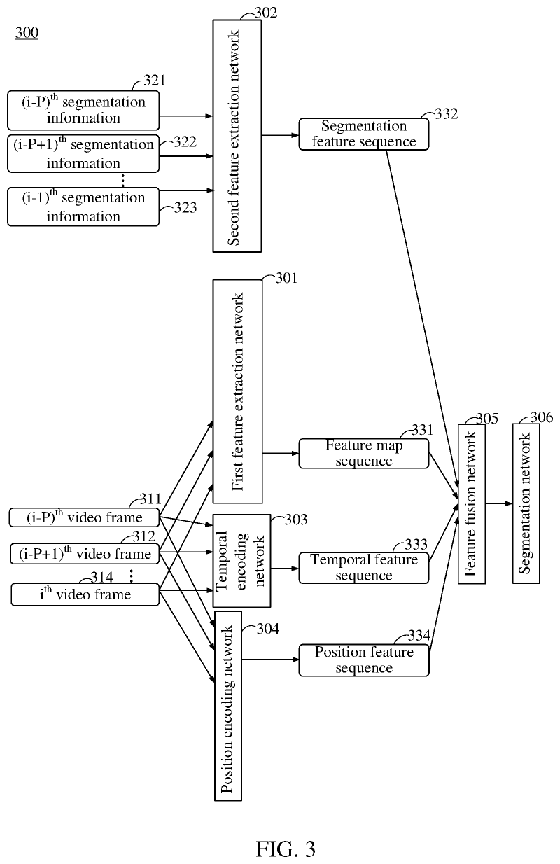

FIG. 3 shows a schematic diagram of a method of performing an object segmentation on a video using a semantic segmentation model according to embodiments of the present disclosure.

According to embodiments of the present disclosure, as shown in FIG. 3, in an embodiment 300, the semantic segmentation model may further include a position encoding network 304 in addition to the first feature extraction network 301, the second feature extraction network 302, the temporal encoding network 303, the feature fusion network 305 and the segmentation network 306 described above. The position encoding network 304 is used to encode a position of each pixel in each video frame.

In this embodiment, if the previous video frame includes P frames, then when the object segmentation is performed on the current video frame (for example, an i^{th} video frame) in the video, the previous P video frames (an (i-P)^{th} video frame 311, an (i-P+1)^{th} video frame 312, . . . an (i-1)^{th} video frame) and the i^{th} video frame 314 are sequentially input into the first feature extraction network 301, the temporal encoding network 303 and the position encoding network 304 at the same time to respectively obtain a feature map sequence 331, a temporal feature sequence 333 and a position feature sequence 334. While the object segmentation information of the previous P video frames (an (i-P))^{th} segmentation information 321, an (i-P+1)^{th} segmentation information 322, . . . , an (i-1)^{th} segmentation information 323 are sequentially input into the second feature extraction network 302 to obtain a segmentation feature sequence 332. Then, the feature map sequence 331, the segmentation feature sequence 332, the temporal feature sequence 333 and the position feature sequence 334 are input into the feature fusion network 305 to obtain a fused feature sequence concatenated in the channel dimension. The fused feature sequence is input into the segmentation network 306, and the object segmentation information of the i^{th} video frame 314 may be obtained, wherein i is a natural number, and a maximum value of i is the number of video frames contained in the video.

According to embodiments of the present disclosure, the position encoding network 304 may generate a position feature of each video frame based on a position information of each pixel in each video frame. For example, each pixel of each video frame may be encoded using a trigonometric function position encoding method, a learning position encoding method or a relative position expression method according to a coordinate value of that pixel in a coordinate system established based on that video frame, so as to obtain a position code for each pixel, which may be represented as a C₁₁-dimensional vector. Then, the position codes corresponding to each video frame may be H*W C₁₁-dimensional vectors, which may form a tensor [symbol] ^{C}^{₁₁}^{×H×W} representing the position feature. In an embodiment, a value of C₁₁ may be 1.

In an embodiment, the position encoding network 304 may generate the position feature using the trigonometric function position encoding method. Firstly, all pixels of each video frame may be rearranged into a one-dimensional pixel vector. For each pixel in the one-dimensional pixel vector, the position code for each pixel may be obtained by using the following equations:

$$\begin{matrix}PE ( pos , 2 j ) = sin ( \frac{pos}{10000 \frac{2 j}{d}} ) ; \\ PE ( pos , 2 j + 1 ) = cos ( \frac{pos}{10000 \frac{2 j}{d}} ) ,\end{matrix}$$

wherein pos represents a position of each pixel in the one-dimensional pixel vector, d represents a dimension of the position code for each pixel, a value of j is any integer between values rounded down from 0 and d/2, or a value of j is any integer between values rounded up from 0 and d/2. In this way, a position code with dimension d may be generated for each pixel. PE(pos, 2j) represents a value for an even-numbered position in the position code, and PE(pos, 2j+1) represents a value for an odd-numbered position in the position code.

After the position feature sequence is generated, the position feature and the temporal feature may be fused with the feature map to obtain a fused feature sequence using a method similar to the method of fusing the temporal feature and the feature map described above.

In this embodiment, when the object segmentation is performed on the video, not only the temporal feature but also the position feature is considered, so that an object detection model may further mine an association between various pixels in the video frame on the basis of mining the temporal association between the object to be segmented in the video frame and the object in the historical frame. Thus, the accuracy of the object segmentation of the video may be further improved.

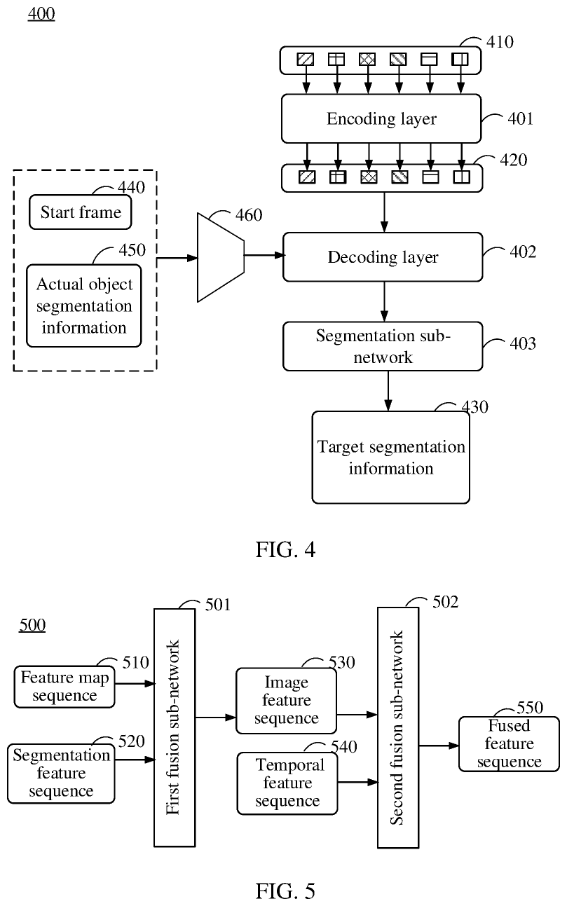

FIG. 4 shows a schematic diagram of generating the object segmentation information of the current video frame according to embodiments of the present disclosure.

According to embodiments of the present disclosure, an attention module may be inserted into the above-mentioned decoder structure of the segmentation network, so as to obtain a dense pixel-level context information and improve an accuracy of the predicted object segmentation information. In this embodiment, the video segmentation may be regarded as a sequence-to-sequence prediction task, and an encoding-decoding module constructed based on a Self-Attention mechanism is used as the attention module.

Accordingly, the segmentation network may include an encoding and decoding sub-network and a segmentation sub-network. When generating the object segmentation information of the current frame, the fused feature sequence may be input into the encoding and decoding sub-network, and features output by the encoding and decoding sub-network form an instance feature sequence. Then, the instance feature sequence is input into the segmentation sub-network to obtain the object segmentation information of the current video frame.

In an embodiment, the encoding and decoding sub-network may be formed by a Transformer model constructed based on the Self-Attention mechanism. As the Transformer model may be used to perform the sequence-to-sequence task and is good at modeling a long sequence, it is suitable for modeling a temporal information of a plurality of video frames in the video field. Moreover, Transformer's core mechanism (i.e., the Self-Attention mechanism) may be implemented to learn and update features based on a similarity between two. Therefore, a use of the Transformer model may improve the accuracy of the semantic segmentation model and improve the accuracy of the generated object segmentation information.

As shown in FIG. 4, in an embodiment 400, the encoding and decoding sub-network in the segmentation network may include an encoding layer 401 and a decoding layer 402. In this embodiment, after the fused feature sequence is obtained, the fused feature sequence 410 may be input into the encoding layer 401. The encoding layer 401 may fuse and update all the features in the fused feature sequence 410 by learning the similarity between the pixels, and an encoded feature sequence 420 is output by the encoding layer 401. After the encoded feature sequence is input into the decoding layer 402, the encoded feature sequence is decoded by the decoding layer 402, and the instance feature sequence is output. After the instance feature sequence is input into the segmentation sub-network 403 and processed by the segmentation sub-network 403, an object segmentation information 430 may be output.

According to embodiments of the present disclosure, reference feature data may be introduced based on the start frame, so that the decoding layer 402 may generate sparse instance features based on the input encoded feature sequence 420. As the encoded feature sequence 420 is a dense pixel feature sequence, the accuracy of the decoded instance feature data may be improved by introducing the reference feature data.

For example, as shown in FIG. 4, in the embodiment 400, the method of performing the object segmentation on the video using the semantic segmentation model may further include an operation of inputting a start frame 440 and an actual object segmentation information 450 of the start frame into a predetermined feature extraction model 460 to obtain the reference feature data. The predetermined feature extraction model 460 may include, for example, two feature extraction branches and a fusion network. Two networks constituting the two feature extraction branches are respectively similar to the first feature extraction network and the second feature extraction network described above. The fusion network may fuse two features output by the two feature extraction branches to obtain the reference feature data by using the method of fusing the feature map and the segmentation feature mentioned above. After the reference feature data is obtained, the reference feature data and the encoded feature sequence 420 output by the encoding layer 401 may be input into the decoding layer 402 and processed by the decoding layer 402, then the instance feature sequence is output.

FIG. 5 shows a schematic diagram of generating a fused feature sequence using a feature fusion network according to embodiments of the present disclosure.

As shown in FIG. 5, a feature fusion network in an embodiment 500 may include a first fusion sub-network 501 and a second fusion sub-network 502. When the feature fusion network fuses the feature map sequence, the segmentation feature sequence and the temporal feature sequence, a feature map sequence 510 and a segmentation feature sequence 520 may be input into the first fusion sub-network 501, and processed by the first fusion sub-network 501 to output an image feature sequence 530. Then, the image feature sequence 530 and a temporal feature sequence 540 are input into a second fusion sub-network 502, and fused by the second fusion sub-network in the channel dimension, so as to obtain a fused feature sequence 550 fused in the channel dimension.

According to embodiments of the present disclosure, when the position feature sequence is obtained using the method described above, the position feature sequence and the temporal feature sequence 540 are simultaneously input into the second fusion sub-network 502. The second fusion sub-network fuses the input three feature sequences in the channel dimension to obtain a fused feature sequence.

For example, the first fusion sub-network may expand the feature map of the previous video frame into a feature map of D×(P×H×W), and the expanded feature map is cross-multiplied with the feature map (H×W)×D of the current video frame to obtain a correlation matrix (H×W)×(H×W×D). The correlation matrix is normalized in a column direction via a softmax function, and cross-multiplied with the segmentation feature of the previous video frame to obtain an image feature. Based on the above-described method, an image feature may be obtained according to each video frame in the previous video frame and the current video frame, then an image feature sequence may be obtained. D is the number of channels.

For example, if each image feature in the image feature sequence has a size of D×(H×W), then each image feature is fused with the corresponding temporal feature in the channel dimension by the second fusion sub-network 502, and a fused feature with a size of (D+1)×(H×W) may be obtained. If performing a fusion on the position feature at the same time, the obtained fused feature has a size of (D+2)×(H×W). An overall size of the fused feature sequence is (1+P)×(D+2)×(H×W).

According to embodiments of the present disclosure, after generating the fused feature, the second fusion sub-network may, for example, reshape the fused feature. For example, the generated sequence with the overall size of (1+P)×(D+2)×(H×W) may be reshaped into a feature with a size of (1+T)HW×(D+2). After the feature is disassembled, a one-dimensional feature (1+T)HW of each channel may be obtained. The one-dimensional features of the (D+2) channels are input into the encoding and decoding sub-network as the fused feature sequence. Therefore, the Transformer model and other sequence models may be used as the encoding and decoding sub-network.

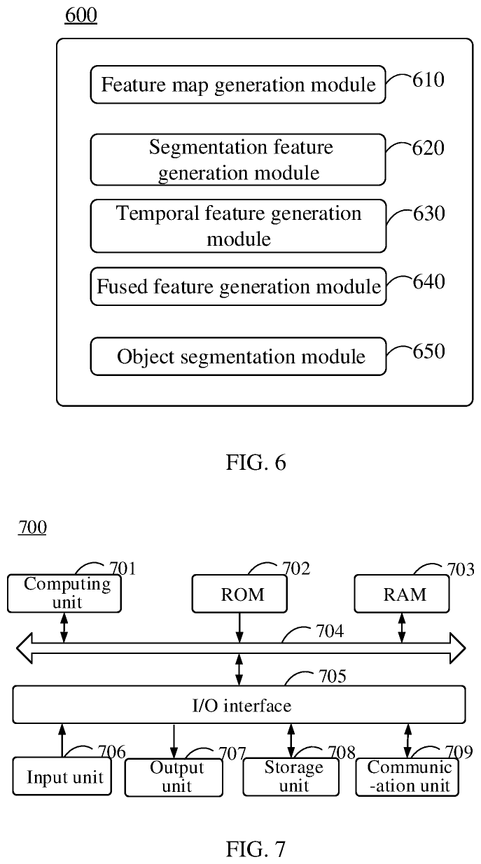

Based on the method of performing the object segmentation on the video by using the semantic segmentation model provided by the present disclosure, the present disclosure further provides an apparatus of performing an object segmentation on a video by using a semantic segmentation model. The apparatus will be described in detail below with reference to FIG. 6.

FIG. 6 shows a structural block diagram of an apparatus of performing an object segmentation on a video using a semantic segmentation model according to embodiments of the present disclosure.

As shown in FIG. 6, an apparatus 600 of performing an object segmentation on a video using a semantic segmentation model in this embodiment may include a feature map generation module 610, a segmentation feature generation module 620, a temporal feature generation module 630, a fused feature generation module 640, and an object segmentation module 650. The semantic segmentation model includes a first feature extraction network, a second feature extraction network, a temporal encoding network, a feature fusion network and a segmentation network.

The feature map generation module 610 is used to sequentially input a current video frame and a previous video frame into the first feature extraction network to obtain a feature map sequence. In an embodiment, the feature map generation module 610 may be used to perform the operation S210 described above, which will not be repeated here.

The segmentation feature generation module 620 is used to sequentially input object segmentation information of the previous video frame into the second feature extraction network to obtain a segmentation feature sequence. In an embodiment, the segmentation feature generation module 620 may be used to perform the operation S220 described above, which will not be repeated here.

The temporal feature generation module 630 is used to sequentially input the current video frame and the previous video frame into the temporal encoding network to obtain a temporal feature sequence. In an embodiment, the temporal feature generation module 630 may be used to perform the operation S230 described above, which will not be repeated here.

The fused feature generation module 640 is used to generate a fused feature sequence using the feature fusion network based on the feature map sequence, the segmentation feature sequence and the temporal feature sequence. In an embodiment, the fused feature generation module 640 may be used to perform the operation S240 described above, which will not be repeated here.

The object segmentation module 650 is used to input the fused feature sequence into the segmentation network to obtain an object segmentation information of the current video frame. In an embodiment, the object segmentation module 650 may be used to perform the operation S250 described above, which will not be repeated here.

According to embodiments of the present disclosure, the semantic segmentation model further includes a position encoding network. The apparatus 600 may further include a position feature generation module used to sequentially input the current video frame and the previous video frame into the position encoding network to obtain a position feature sequence. The fused feature generation module 640 may be used, for example, to input the feature map sequence, the segmentation feature sequence, the temporal feature sequence and the position feature sequence into the feature fusion network to obtain a fused feature sequence concatenated in a channel dimension.

According to embodiments of the present disclosure, the segmentation network includes an encoding and decoding sub-network and a segmentation sub-network. The object segmentation module 650 may include an encoding and decoding sub-module and an object segmentation sub-module. The encoding and decoding sub-module is used to input the fused feature sequence into the encoding and decoding sub-network to obtain an instance feature sequence. The object segmentation sub-module is used to input the instance feature sequence into the segmentation sub-network to obtain the object segmentation information of the current video frame.

According to embodiments of the present disclosure, the encoding and decoding sub-network includes an encoding layer and a decoding layer. The apparatus 600 may further include a reference feature generation module used to input a start frame and an actual object segmentation information of the start frame into a predetermined feature extraction model to obtain reference feature data. The encoding and decoding sub-module may include an encoding unit and a decoding unit. The encoding unit is used to input the fused feature sequence into the encoding layer to obtain an encoded feature sequence. The decoding unit is used to input the encoded feature sequence and the reference feature data into the decoding layer to obtain the instance feature sequence.

According to embodiments of the present disclosure, the encoding and decoding sub-network may generate the instance feature sequence using a Transformer model.

According to embodiments of the present disclosure, the temporal feature generation module 630 may be used to sequentially input the current video frame and the previous video frame into the temporal encoding network based on a temporal order, and generate a temporal feature of each input video frame by the temporal encoding network using a sine wave encoding method based on a temporal information of each input video frame relative to the start frame.

According to embodiments of the present disclosure, the feature fusion network may include a first fusion sub-network and a second fusion sub-network. The fused feature generation module 640 may include a first fusion sub-module and a second fusion sub-module. The first fusion sub-module is used to input the feature map sequence and the segmentation feature sequence into the first fusion sub-network to obtain an image feature sequence. The second fusion sub-module is used to input the image feature sequence and the temporal feature sequence into the second fusion sub-network to obtain a fused feature sequence fused in the channel dimension.

In the technical solution of the present disclosure, the collection, storage, use, processing, transmission, provision, disclosure and application of the user's personal information involved are all in compliance with the provisions of relevant laws and regulations, and necessary confidentiality measures have been taken, and it does not violate public order and good morals. In the technical solution of the present disclosure, before obtaining or collecting the user's personal information, the user's authorization or consent is obtained.

According to embodiments of the present disclosure, the present disclosure further provides an electronic device, a readable storage medium, and a computer program product.

FIG. 7 shows a schematic block diagram of an exemplary electronic device 700 for implementing the method of performing the object segmentation on the video by using the semantic segmentation model The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, the electronic device 700 may include a computing unit 701, which may perform various appropriate actions and processing based on a computer program stored in a read-only memory (ROM) 702 or a computer program loaded from a storage unit 708 into a random access memory (RAM) 703. Various programs and data required for the operation of the electronic device 700 may be stored in the RAM 703. The computing unit 701, the ROM 702 and the RAM 703 are connected to each other through a bus 704. An input/output (I/O) interface 705 is further connected to the bus 704.

Various components in the electronic device 700, including an input unit 706 such as a keyboard, a mouse, etc., an output unit 707 such as various types of displays, speakers, etc., a storage unit 708 such as a magnetic disk, an optical disk, etc., and a communication unit 709 such as a network card, a modem, a wireless communication transceiver, etc., are connected to the I/O interface 705. The communication unit 709 allows the electronic device 700 to exchange information/data with other devices through a computer network such as the Internet and/or various telecommunication networks.

The computing unit 701 may be various general-purpose and/or special-purpose processing components with processing and computing capabilities. Some examples of the computing unit 701 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 701 may perform the various methods and processes described above, such as the method of performing the object segmentation on the video by using the semantic segmentation model. For example, in some embodiments, the method of performing the object segmentation on the video by using the semantic segmentation model may be implemented as a computer software program that is tangibly contained on a machine-readable medium, such as the storage unit 708. In some embodiments, part or all of a computer program may be loaded and/or installed on the electronic device 700 via the ROM 702 and/or the communication unit 709. When the computer program is loaded into the RAM 703 and executed by the computing unit 701, one or more steps of the method of performing the object segmentation on the video by using the semantic segmentation model described above may be performed. Alternatively, in other embodiments, the computing unit 701 may be configured to perform the method of performing the object segmentation on the video by using the semantic segmentation model in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, also known as a cloud computing server or a cloud host, which is a host product in a cloud computing service system to overcome the defects of difficult management and weak business expansion in traditional physical hosts and VPS (“Virtual Private Server”, or “VPS” for short) services. The server may also be a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of performing an object segmentation on a video using a semantic segmentation model, wherein the semantic segmentation model comprises a first feature extraction network, a second feature extraction network, a temporal encoding network, a feature fusion network and a segmentation network, the method comprising:
sequentially inputting a current video frame and a previous video frame into the first feature extraction network to obtain a feature map sequence;
sequentially inputting object segmentation information of the previous video frame into the second feature extraction network to obtain a segmentation feature sequence;
sequentially inputting the current video frame and the previous video frame into the temporal encoding network to obtain a temporal feature sequence;
generating a fused feature sequence using the feature fusion network based on the feature map sequence, the segmentation feature sequence and the temporal feature sequence; and
inputting the fused feature sequence into the segmentation network to obtain an object segmentation information of the current video frame.

2. The method of claim 1, wherein the semantic segmentation model further comprises a position encoding network,
further comprising sequentially inputting the current video frame and the previous video frame into the position encoding network to obtain a position feature sequence, and
wherein the generating a fused feature sequence using the feature fusion network comprises inputting the feature map sequence, the segmentation feature sequence, the temporal feature sequence and the position feature sequence into the feature fusion network to obtain a fused feature sequence concatenated in a channel dimension.

3. The method of claim 1, wherein the segmentation network comprises an encoding and decoding sub-network and a segmentation sub-network, and
wherein the object segmentation information of the current video frame is obtained by:
inputting the fused feature sequence into the encoding and decoding sub-network to obtain an instance feature sequence; and
inputting the instance feature sequence into the segmentation sub-network to obtain the object segmentation information of the current video frame.

4. The method of claim 3, wherein the encoding and decoding sub-network comprises an encoding layer and a decoding layer,
further comprising inputting a start frame and an actual object segmentation information of the start frame into a predetermined feature extraction model to obtain reference feature data, and
wherein the instance feature sequence is obtained by:
inputting the fused feature sequence into the encoding layer to obtain an encoded feature sequence; and
inputting the encoded feature sequence and the reference feature data into the decoding layer to obtain the instance feature sequence.

5. The method of claim 3, wherein the instance feature sequence is obtained by the encoding and decoding sub-network using a Transformer model.

6. The method of claim 1, wherein the temporal feature sequence is obtained by:
sequentially inputting the current video frame and the previous video frame into the temporal encoding network based on a temporal order; and
generating a temporal feature of each input video frame by the temporal encoding network using a sine wave encoding method based on a temporal information of the input video frame relative to a start frame.

7. The method of claim 1, wherein the feature fusion network comprises a first fusion sub-network and a second fusion sub-network, and
wherein the generating a fused feature sequence using the feature fusion network comprises:
inputting the feature map sequence and the segmentation feature sequence into the first fusion sub-network to obtain an image feature sequence; and
inputting the image feature sequence and the temporal feature sequence into the second fusion sub-network to obtain the fused feature sequence fused in a channel dimension.

8. An electronic device, comprising:
at least one processor; and
a memory communicatively connected to the at least one processor, wherein a semantic segmentation model comprises a first feature extraction network, a second feature extraction network, a temporal encoding network, a feature fusion network and a segmentation network, and wherein the memory stores instructions, the instructions, when executed by the at least one processor, cause the at least one processor to at least:
sequentially input a current video frame and a previous video frame into the first feature extraction network to obtain a feature map sequence;
sequentially input object segmentation information of the previous video frame into the second feature extraction network to obtain a segmentation feature sequence;
sequentially input the current video frame and the previous video frame into the temporal encoding network to obtain a temporal feature sequence;
generate a fused feature sequence using the feature fusion network based on the feature map sequence, the segmentation feature sequence and the temporal feature sequence; and
input the fused feature sequence into the segmentation network to obtain an object segmentation information of the current video frame.

9. The electronic device of claim 8, wherein the semantic segmentation model further comprises a position encoding network,
wherein the instructions are further configured to cause the at least one processor to sequentially input the current video frame and the previous video frame into the position encoding network to obtain a position feature sequence, and
wherein the fused feature sequence is generated by input of the feature map sequence, the segmentation feature sequence, the temporal feature sequence and the position feature sequence into the feature fusion network to obtain a fused feature sequence concatenated in a channel dimension.

10. The electronic device of claim 8, wherein the segmentation network comprises an encoding and decoding sub-network and a segmentation sub-network, and
wherein the instructions are further configured to cause the at least one processor to:
input the fused feature sequence into the encoding and decoding sub-network to obtain an instance feature sequence; and
input the instance feature sequence into the segmentation sub-network to obtain the object segmentation information of the current video frame.

11. The electronic device of claim 10, wherein the encoding and decoding sub-network comprises an encoding layer and a decoding layer, and
wherein the instructions are further configured to cause the at least one processor to input a start frame and an actual object segmentation information of the start frame into a predetermined feature extraction model to obtain reference feature data, and
wherein the instance feature sequence is obtained by:
input of the fused feature sequence into the encoding layer to obtain an encoded feature sequence; and
input of the encoded feature sequence and the reference feature data into the decoding layer to obtain the instance feature sequence.

12. The electronic device of claim 10, wherein the instance feature sequence is obtained by the encoding and decoding sub-network using a Transformer model.

13. The electronic device of claim 8, wherein the instructions are further configured to cause the at least one processor to:
sequentially input the current video frame and the previous video frame into the temporal encoding network based on a temporal order; and
generate a temporal feature of each input video frame by the temporal encoding network using a sine wave encoding method based on a temporal information of the input video frame relative to a start frame.

14. The electronic device of claim 8, wherein the feature fusion network comprises a first fusion sub-network and a second fusion sub-network, and
wherein the instructions are further configured to cause the at least one processor to:
input the feature map sequence and the segmentation feature sequence into the first fusion sub-network to obtain an image feature sequence; and
input the image feature sequence and the temporal feature sequence into the second fusion sub-network to obtain the fused feature sequence fused in a channel dimension.

15. A non-transitory computer-readable storage medium having computer instructions therein, wherein a semantic segmentation model comprises a first feature extraction network, a second feature extraction network, a temporal encoding network, a feature fusion network and a segmentation network, and the computer instructions are configured to cause a computer system to at least:
sequentially input a current video frame and a previous video frame into the first feature extraction network to obtain a feature map sequence;
sequentially input object segmentation information of the previous video frame into the second feature extraction network to obtain a segmentation feature sequence;
sequentially input the current video frame and the previous video frame into the temporal encoding network to obtain a temporal feature sequence;
generate a fused feature sequence using the feature fusion network based on the feature map sequence, the segmentation feature sequence and the temporal feature sequence; and
input the fused feature sequence into the segmentation network to obtain an object segmentation information of the current video frame.

16. The non-transitory computer-readable storage medium of claim 15, wherein the semantic segmentation model further comprises a position encoding network, and
wherein the computer instructions are further configured to cause the computer system to at least sequentially input the current video frame and the previous video frame into the position encoding network to obtain a position feature sequence, and
wherein the fused feature sequence is generated by input of the feature map sequence, the segmentation feature sequence, the temporal feature sequence and the position feature sequence into the feature fusion network to obtain a fused feature sequence concatenated in a channel dimension.

17. The non-transitory computer-readable storage medium of claim 15, wherein the segmentation network comprises an encoding and decoding sub-network and a segmentation sub-network, and
wherein the computer instructions are further configured to cause the computer system to at least:
input the fused feature sequence into the encoding and decoding sub-network to obtain an instance feature sequence; and
input the instance feature sequence into the segmentation sub-network to obtain the object segmentation information of the current video frame.

18. The non-transitory computer-readable storage medium of claim 17, wherein the encoding and decoding sub-network comprises an encoding layer and a decoding layer,
wherein the computer instructions are further configured to cause the computer system to at least input a start frame and an actual object segmentation information of the start frame into a predetermined feature extraction model to obtain reference feature data, and
wherein the instance feature sequence is obtained by:
input of the fused feature sequence into the encoding layer to obtain an encoded feature sequence; and
input of the encoded feature sequence and the reference feature data into the decoding layer to obtain the instance feature sequence.

19. The non-transitory computer-readable storage medium of claim 17, wherein the instance feature sequence is obtained by the encoding and decoding sub-network using a Transformer model.

20. The non-transitory computer-readable storage medium of claim 15, wherein the computer instructions are further configured to cause the computer system to at least:
sequentially input the current video frame and the previous video frame into the temporal encoding network based on a temporal order; and
generate a temporal feature of each input video frame by the temporal encoding network using a sine wave encoding method based on a temporal information of the input video frame relative to a start frame.
